(19) United States
(12) Patent Application Publication
(10) Pub. No.: US 2020/0277896 A1
(43) Pub. Date: Sep. 3, 2020

(54) SYSTEM AND METHOD TO STORE AND GENERATE ENERGY WHERE A PRESSURE IS RELEASED INTO A LIQUID CIRCUIT WHICH IN TURN MOVES A LIQUID TURBINE TO GENERATE POWER

(71) Applicant: Universidad Técnica Federico Santa María, Valparaiso (CL)

(72) Inventors: Christian Romero, Casa Blanca (CL); David Aliaga, Santiago (CL); Pablo Bunout, Valparaiso (CL)

(73) Assignee: Universidad Técnica Federico Santa María, Valparaiso (CL)

(21) Appl. No.: 16/650,832

(22) PCT Filed: Sep. 27, 2017
(86) PCT No.: PCT/CL2017/050055

§ 371 Date: Mar. 25, 2020

(51) Int. Cl. F02C 6/16; F03G 7/04

(52) U.S. Cl. CPC F02C 6/16; F03G 6/00; F03G 7/04

(57) ABSTRACT

A pressure of a working compressed fluid is released into a liquid circuit to drive a turbine for energy generation, comprising a compressor and a primary tank of high pressure, a first main tank of liquid and a second main tank of liquid, an auxiliary tank of liquid, a turbine of liquid located between the first and the second main tanks, and at a lower level than that of the bottom of the main and second and auxiliary tank, to ensure that the pressure inside the tanks forces the liquid in the proper direction through the turbine, a network of pipelines with their respective valves, such as inlet valves, outlet valves, control valves or pressure-regulating valves, as well as ventilation valves; where the operation is performed in short cycles and at a constant pressure by means of a control system that acts on at least one pressure-regulating valve.

### CROSS-REFERENCE TO RELATED APPLICATION

The present application claims priority to International PCT patent application No. PCT/CL2017/050055 filed on Sep. 27, 2017, the content of which in its entirety is included herein by reference.

### BACKGROUND

### Field of the Invention

The present invention concerns energy storage, more specifically a short cycle energy generation and storage system at constant pressure (liquid-gas), more specifically to a system and method that uses compressed gas to pressurize a liquid tank that in turn actuates a liquid turbine to produce electrical energy. The storage is done by storing compressed gas at a high pressure in small or medium high-pressure containers.

### Description of the Prior Art

Solar and wind energy are great candidates for massive electricity generation in the future. However, peak electricity generation times for both often do not coincide with the peak hours of user demand. Therefore, the profitable use of solar and wind energy necessarily involves finding a cost-effective way of storing the surplus energy and releasing it to the power grid when needed. To address this issue, many avenues have been explored. One is to use the electricity surplus to pump water into reservoirs located at height, from which by allowing water to descend later it is possible for the system to behave like a waterfall harnessed by hydroelectric power plants. Another is to resort to electrochemical batteries, however, the existing cost of battery technology is still high.

For the above reasons, it has become the primary objective to store energy at the lowest possible cost. According to Yao E, Wang H, Liu L, Xi G. “A novel constant-pressure pumped hydro combined with compressed air energy storage system”. Energies 2015; 8:154-71 and Erren Yao, Huanran Wang, Ligang Wang, Guang Xi, François Maréchal, “Thermo-economic optimization of a combined cooling, heating and power system based on small-scale compressed air energy storage”. Energy Conversion and Management 118 (2016) 377-386, the only technology that has the capability to reach 400 USD/kW per installation is the “virtual dam” approach.

The “Virtual Dam” is not a new concept, it was coined in 2011 in some academic publications, another term used in this sense is that of “virtual head”.

Several patent documents suggest similar solutions that utilize gas pressure to store energy, see for example U.S. Pat. No. 8,359,856 B2, entitled “Systems and methods for efficient pumping of high-pressure fluids for energy storage and recovery”, describes a mechanical assembly and/or storage vessel that is coupled in a fluid manner to a circulation device in order to receive pressurized-heat-transfer-fluid from an outlet into a first elevated pressure, increasing a heat-transfer pressure fluid to a second pressure that is higher than the first pressure and to return the heat-transfer fluid to a third pressure inlet.

Patent document U.S. Pat. No. 8,037,678 B2, titled “Energy storage and generation systems and methods using coupled cylinder assemblies”, describes a system for energy storage and recovery through the expansion and compression of a gas and that is suitable for the efficient use and conservation of energy resources.

Patent document U.S. Pat. No. 7,579,700 B1, titled “System and method for converting electrical energy into pressurized air and converting pressurized air into electricity”, describes a system to convert electricity into pressurized air, and to convert pressurized air into electricity. The system includes a pressurized air reservoir, two high pressure tanks, one pump and an electric motor convertible into a hydraulic turbine and an electricity generator, a volume of water equal to the volume of a tank, a set of controllable valves to independently connect and disconnect each tank to the atmosphere, to the entrance and exit of the pump, and to the air reservoir. During use, a volume of water is pumped from the first tank to the second tank, the air in the second tank is compressed and flows into the air reservoir. Changing the position of the valves, the operation is repeated with opposite functions of the tanks. In an electricity generation mode, the system works by transferring pressurized air from the air reservoir into the first tank that is filled with water, flowing the pressurized water through the hydraulic turbine generator generating electricity. The main characteristic that separates said patent with the present invention is the fact that the constant pressure is managed by a control mechanism and is not subject to deposit sizes. Another important difference is that a liquid pump is not used, the pressure is generated with an external compressor.

Furthermore, the present invention does not store energy in huge caverns or large artificial tanks to store the pressure; pressure can be controlled through artificial means; land use is minimized; has a distributed energy storage approach, and therefore without a monstrous size installation.

This is in accordance with Boyle's law. Indeed, if we store air at a pressure P=2P0, then the required volume decreases linearly, when compared to the storage of this same air at P0. This capability to maintain pressure in artificial tanks that are extremely resistant is what allows the possibility of having 1 MWh of energy in a small area.

### SUMMARY OF THE INVENTION

The present invention is a system and method that uses a pressurized working fluid, such as compressed air, or liquid air, i.e. air at cryogenic temperature that is stored at atmospheric pressure and that when injected into the liquid tanks it heats up and increases its volume between 600 and 800 times, thus generating pressure to pressurize a liquid-tank, which in turn actuates a liquid-driven turbine to produce electric energy. The storage is done by storing the working fluid at a high pressure in small high-pressure vessels. These vessels are available on today's market. They can be made of carbon fibers, or advanced metal alloys, or any high-resistance composite material.

According to one modality, the pressure is generated by a compressor during low energy-production hours, if the energy of the network is used. But it can also be provided by other energy sources, such as photovoltaic installations, wind turbines, etc.

It is also possible to consider a plant that generates compressed air or other gas with unused pressure, this pressure can be used to actuate the present invention by external sources.

Therefore, the present invention can store energy in the form of pressure. The pressure is released, when necessary, into a liquid circuit which in turn moves a liquid turbine. This liquid could be water and the gas under pressure can be air or nitrogen. Generally speaking, a liquid is any liquid that is not miscible with the gas that provides the pressure.

According to the above, a first objective is to provide a system to store and generate energy, where a pressure, preferably of compressed gas, is released into a liquid circuit which in turn drives a turbine to generate energy, which comprises a compressor; a high-pressure primary tank; a first main liquid tank and a second main liquid tank; an auxiliary liquid tank; a liquid turbine located between the first and second main tanks and at a lower level than the level of the bottom of the first and the second main tanks and auxiliary tank, to ensure that the pressurized working fluid forces the liquid through the turbine and not in the opposite sense; a network of pipes with their respective valves, both inlet valves, outlet valves, control valves as well as ventilation valves; where the operation is done in short cycles and at a constant pressure by means of a control system that acts on at least one pressure regulating valve.

As an additional objective, a method for storing and generating energy is provided, where a pressure, preferably of compressed gas, is released in a liquid circuit which in turn moves a liquid turbine to generate power, which comprises the following stages:

(a) provide a system comprising, optionally, a compressor and a high pressure primary tank, furthermore, comprises a first main liquid tank with a predetermined level of liquid in its interior and a second main tank of liquid without liquid in its interior; an auxiliary tank of liquid with a predetermined liquid level in its interior; a liquid turbine located between the first and second main tanks and at a level lower than the bottom level of the first and second main tanks and auxiliary tank, to ensure that the under-pressure working-fluid forces the liquid through the turbine and not in the opposite sense; a network of pipelines with their respective valves, both inlet valves, outlet valves, control valves as well as ventilation valves; where the operation takes place in short cycles and at a constant pressure by means of a control system that acts on at least one pressure-regulating valve;

(b) optionally, to pressurize the high-pressure primary tank by means of the compressor or to store a gas or a gas mixture at cryogenic temperature, if the system comprises such a compressor and high-pressure primary tank;

(c) to pressurize at an operating or working pressure the first main tank, the auxiliary tank and the network of pipes;

d) to open the first main tank to turbine outlet valve, the second main tank inlet valve and the second main tank ventilation valve, so that the liquid is moved from the first main tank, through the first main tank to turbine outlet valve, up to the turbine and then, through the second main tank inlet valve, it is discharged into the second main tank, while the second main tank ventilation valve allows that the second main tank is filled without increasing the pressure;

(e) to control the pressure in the first main tank through a first main tank control valve which controls the pressure as the liquid level decreases, ensuring in this manner, a stable working pressure;

(f) to close the outlet valves from the first main tank to turbine outlet valve, second main tank inlet valve and second main tank ventilation valve, and to open the auxiliary tank to turbine outlet valve in order to allow that the auxiliary tank feeds the turbine during the transition from one discharge mode to another, while a new operation cycle is initiated;

(g) to open the first main tank ventilation valve and pressurize the second main tank to the operation pressure by means of a second main tank control valve;

h) to open first main tank inlet valve so that the flow can be discharged into the first main tank which is already ventilated or is at atmospheric pressure;

i) to open the auxiliary tank ventilation valve in order to ventilate the pressure from the empty auxiliary tank and to close the auxiliary tank to turbine outlet valve;

j) to open the second main tank to turbine outlet valve in order to feed the turbine from the liquid that comes from the discharge of the second main tank;

k) to close the first main tank to auxiliary tank outlet valve when the auxiliary tank is with the predetermined liquid level of stage a), where this condition is given when the liquid level of the first main tank has reached the necessary level to allow that the liquid enters in the auxiliary tank, e.g. by gravity;

l) to control the pressure of the second main tank through the second main tank control valve which controls the pressure as the liquid level decreases, thus ensuring a stable working pressure; and

m) to close all opened valves and start the stages from stage d) up to stage m).

According to one mode of the invention, the control system which acts on at least one pressure regulating valve, maintaining control over the working pressure of the whole system, also acts on the control of the other system components, such as inlet, outlet, ventilation and control valves, where such control system is configured to execute the method of the invention.

On the other hand, although the invention contemplates the implementation of actuators and level and/or pressure sensors, among others, as part of the proposed control system, the use of said components shall not be considered as a restriction to the invention, every time their use is usual in the technical field of the invention.

### BRIEF DESCRIPTION OF THE DRAWINGS

FIG. 1 shows a general schematic representation of a system of the present invention.

FIG. 2 shows a schematic representation of the functioning of a system of the invention, where the system is ready to start generating energy.

FIG. 3 shows a schematic representation of a system of the present invention where the first main tank has been emptied, the auxiliary tank has to maintain the power generation while the first main tank and the second main tank are prepared to reverse the flow.

FIG. 4 shows a schematic representation of a system of the present invention where the auxiliary tank has been emptied and the second main tank has been filled.

FIG. 5 shows an intermediate operation stage where once the level of liquid in the first main tank is high enough, the liquid will fill the auxiliary tank. When this stage has been finished, the system will be in the startup configuration shown in FIG. 2.

### DETAILED DESCRIPTION OF THE INVENTION

The present invention has two main interacting parts. On one hand, a working fluid under pressure, for example, a gas, and on the other, a liquid. Therefore, the present invention is a system and method that uses a pressurized-working fluid, such as a compressed gas (for example air), to pressurize tanks with liquid (for example water) which in turn actuates a liquid turbine to produce electric energy. However, the most relevant issue for the efficient production of energy is the capability to maintain a constant pressure. The pressure is monitored with pressure sensors and if more pressure is needed in the system as the liquid is discharged, the control system can react and maintain the desired working conditions by actuating on at least one pressure-regulating valve that provides the working pressure to the system.

The tanks that contain liquid are small. This means that for prolonged functioning time periods the system can work in cycles.

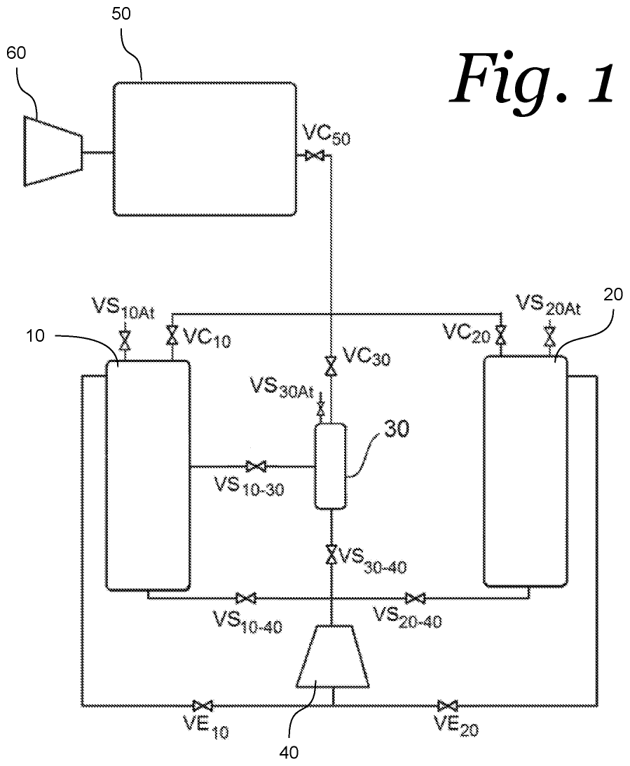

As shown in FIG. 1, the system comprises two liquid tanks or liquid reservoirs, a first main tank 10 and a second main tank 20 and, in addition, at least one auxiliary tank 30 of liquid that functions between cycles to give the system time to restart the cycle without loss of energy generation. An alternative system configuration is with three main tanks or liquid reservoirs, thus eliminating the auxiliary tank.

The system can also comprise a primary tank 50, which corresponds to a high-pressure vessel with a pressure that ranges between 30 bar and 300 bar. This main tank 50 feeds a primary pressure line that is operating at a lower pressure, e.g. 8 bar. This pressure does not exclude other working pressures, neither higher nor lower.

Taking 8 bar as the reference pressure and water as the reference liquid, the pressure is optionally supplied by a compressor 60. If there is a pressure derived from other processes, this pressure can be used to generate electricity, thus the shown compressor would not be necessary.

This pressure of 8 bar is connected, via piping and at least one pressure-regulating valve to the first 10 and second 20 main tanks with a first main tank control valve VC10 and a second main tank control valve VC20, and also to the auxiliary tank 30 via an auxiliary tank control valve VC30. Both liquid inputs and liquid outlets between the first 10 and second 20 main tanks, the auxiliary tank 30 and a turbine 40 have their own valves, which are controlled by an electronic system (not shown).

All the liquid tanks 10, 20, 30 are connected at their bottom part by pipes to the turbine 40. This ensures that the pressurized working fluid will force the liquid through the turbine 40 and not in the opposite sense.

There is a second pipe after the turbine 40 to allow that the flow goes from the first main tank 10, through the opening of an first tank inlet valve VE10, to the second main tank 20 through the opening of a second main tank inlet valve VE20 or in reverse order.

Each of the liquid tanks 10, 20, 30 has a ventilation valve VS10At, VS20At, VS30At that connects the inside with the outside, thus establishing an atmospheric pressure. Said valves are also controlled by an electronic system (not shown).

The auxiliary tank 30 is small compared to the first main tank 10 and the second main tank 20. The purpose of the auxiliary tank 30 is to operate intermittently, e.g. for 20 to 40 seconds, while the system is changing its operating direction in one direction or in the opposite direction. The auxiliary tank 30 can only be omitted if there is an alternative way to manage the downtime in the switching operation. One alternative way would be to operate the system with 3 main tanks, without an auxiliary tank.

The size of the first 10 and second 20 main tanks determines the cycle time. If you wish to operate the first main tank 10 or the second main tank 20 for 3 minutes, then the main tanks have a given size. If it is more suitable for this time to be of 6 minutes, then the main tanks have to be resized to that capacity.

The total operating time is set by the pressure and the size of the high-pressure primary tank 50 or by the pressure and the flow of the working fluid under pressure. According to one modality, it is estimated that this system can produce 1 MW for 4 hours using only 200 m² of terrain. The use of terrain can be reduced if the tanks are made taller.

According to one modality, the high-pressure primary tank 50 is pressurized by means of a compressor 60 through solar energy, or low-cost energy from the grid, or any other convenient way. It can also be pressurized by non-conventional compressors. In accordance with another modality, the primary tank 50 has primary tank pressure-regulating valve VC50 to control the working pressure that said tank delivers to the entire system.

The first main tank 10 is filled with liquid as is the auxiliary tank 30, while the pressure is set at, for example, 8 bar through one or more pressure regulating valves. The first main tank to turbine outlet valve VS10-40 is opened and the second main tank inlet valve VE20 is also opened, which passes through the turbine 40, where the second main tank 20 operates as a discharge tank. The second main tank ventilation valve VS20At is opened, thus having an atmospheric pressure in the second main tank 20.

For the duration of the discharge, the only working elements are the pressure control in the first main tank 10, maintaining a constant working pressure.

When the first main tank 10 approaches its lower limit, the first main tank to turbine outlet valve VS10-40 is closed and the auxiliary tank 30 takes over, where the auxiliary tank to turbine outlet valve VS30-40 opens. This creates a time window, and energy is still being generated. During this window, the first main tank 10 is ventilated at atmospheric pressure, opening the first main tank ventilation valve VS10At, while the second main tank 20 is pressurized to, for example, 8 bar.

When the auxiliary tank 30 reaches its lowest level, the second main tank to turbine outlet valve VS20-40 and first main tank inlet valve VE10 are opened so that the flow from the second main tank 20 passes through the turbine 40 and is discharged into the first main tank 10. Along with that, the auxiliary tank to turbine outlet valve VS30-40 is closed so that the auxiliary tank 30 is also recharged with liquid and pressure, for the next cyclical event.

To reduce losses during the transition from one discharge mode to another, the auxiliary tank 30 can be adjusted to a slightly higher pressure. This compensates for the possible losses generated by the switching. According to one modality, the auxiliary tank 30 is forced to discharge liquid into the first main tank 10 that is lowering the pressure, but that has not yet reached atmospheric pressure.

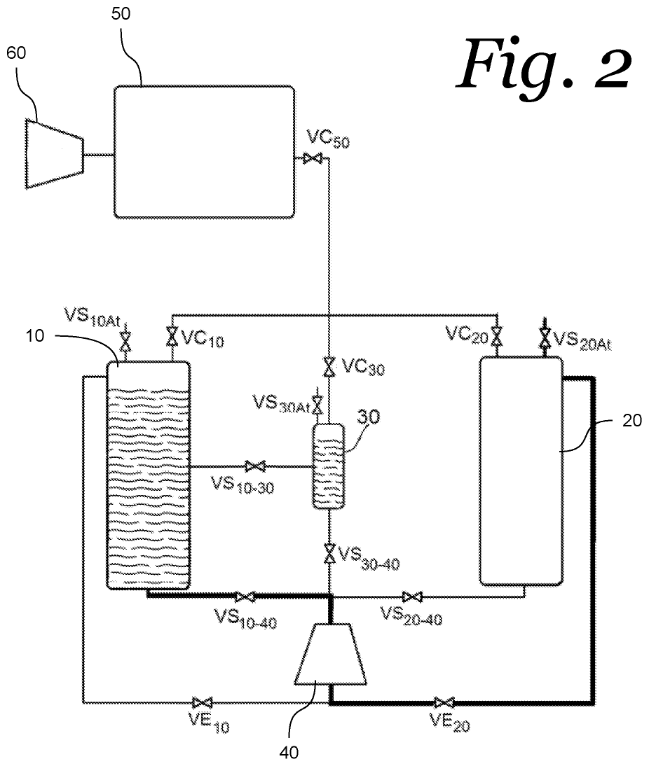

FIG. 2 shows the status of the system when it is ready to start generating energy. The first main tank 10 and the auxiliary tank 30 are full of liquid, for example, water. Both are at a working pressure. The pressure is provided through the connection of pipes that reach the top of each tank, while the first main tank to turbine outlet valve VS10-40, the second main tank inlet valve VE20 that passes through the turbine 40 and the second main tank ventilation valve VS20At are open. All other valves are closed. The liquid goes from the first main tank 10, through the first main tank to turbine outlet valve VS10-40, to the turbine 40. Then, through the second main tank inlet valve VE20 it is discharged into the second main tank 20. The second main tank ventilation valve VS20At remains open. This allows the second main tank 20 to be filled without increasing the pressure. The first main tank 10 has a control valve VC10 that controls the pressure as the liquid level decreases, thus ensuring a stable working pressure. The path taken by the liquid is shown in FIG. 2 by means of a thicker layout of the pipes connecting the various components.

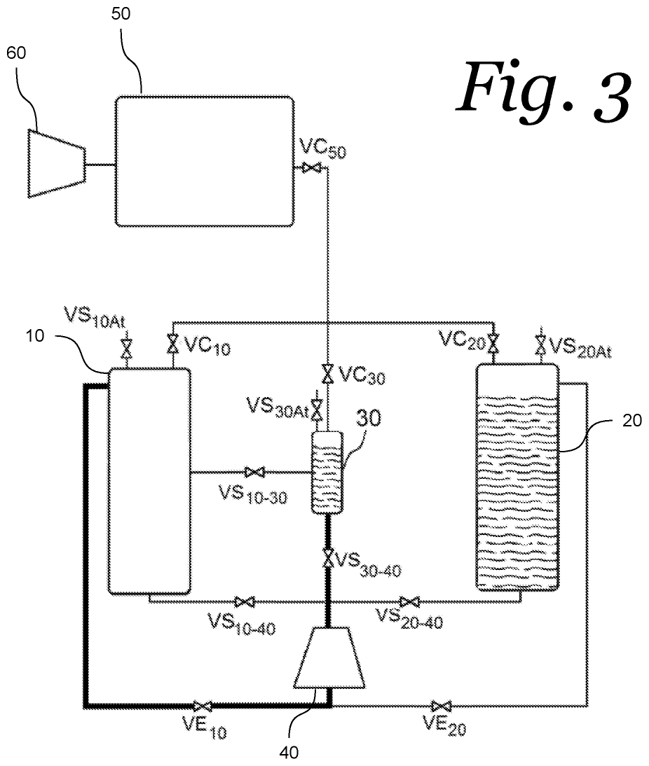

As shown in FIG. 3, the system of the present invention has emptied the first main tank 10. Now the auxiliary tank 30 has to take over the energy generation while the first main tank 10 and the second main tank 20 are prepared to reverse the flow. All the valves are closed. The first main tank ventilation valve VS10At is open to allow that the pressure in the first main tank 10 equalizes atmospheric pressure, the auxiliary tank to turbine output valve VS30-40 is open to allow that the auxiliary tank 30 feeds the turbine 40. The first main tank inlet valve VE10 is opened so that the flow can be discharged into the first main tank 10 which is already in the ventilation process. The second main tank control valve VC20 is opened to increase the pressure in the second main tank 20. The liquid path is shown in FIG. 3 by a thicker pipe layout that connects the various components.

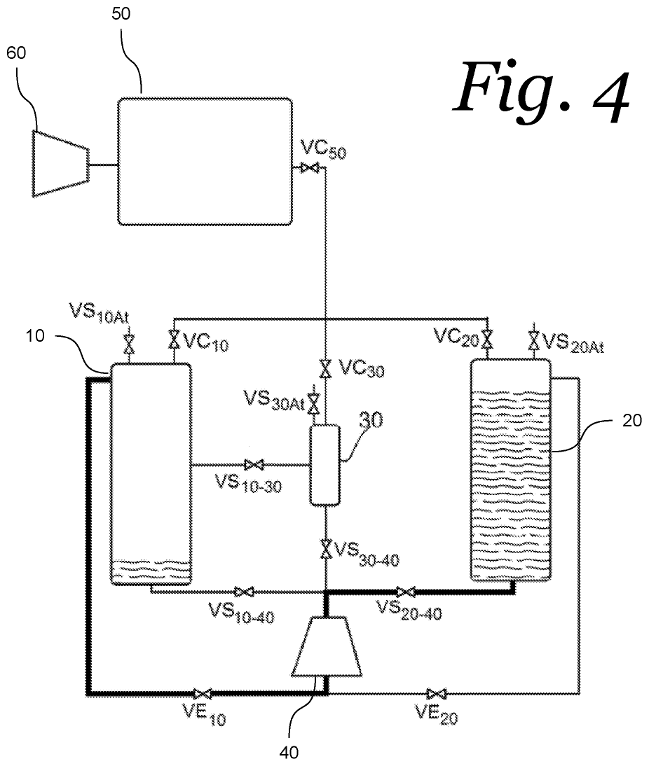

In FIG. 4, the auxiliary tank 30 has been emptied, and the liquid has already been deposited in the first main tank 10. The first main tank ventilation valve VS10At remains open to allow the liquid to be discharged from the second main tank 20 without generating pressure inside the first main tank 10. The first main tank to auxiliary tank outlet valve VS10-30 is open to ventilate the pressure from the auxiliary tank 30, this remains open to fill the auxiliary tank 30 with liquid when the liquid level in the first main tank 10 has reached the level necessary to allow that the liquid enters the auxiliary tank 30, in this example by gravity. The second main tank turbine outlet valve VS20-40 is open to feed the turbine 40, the first main tank inlet valve VE10 remains open to allow that the flow is discharged into the first main tank 10. The second main tank control valve VC20 provides the necessary pressure to the second main tank 20 as the liquid level decreases. This allows that the second main tank 20 has a stable pressure condition. The liquid path is shown in FIG. 4 by a thicker pipe layout connecting the various components. If an overpressure is detected in the auxiliary tank 30, the auxiliary tank ventilation valve VS30At can be opened to discharge this overpressure.

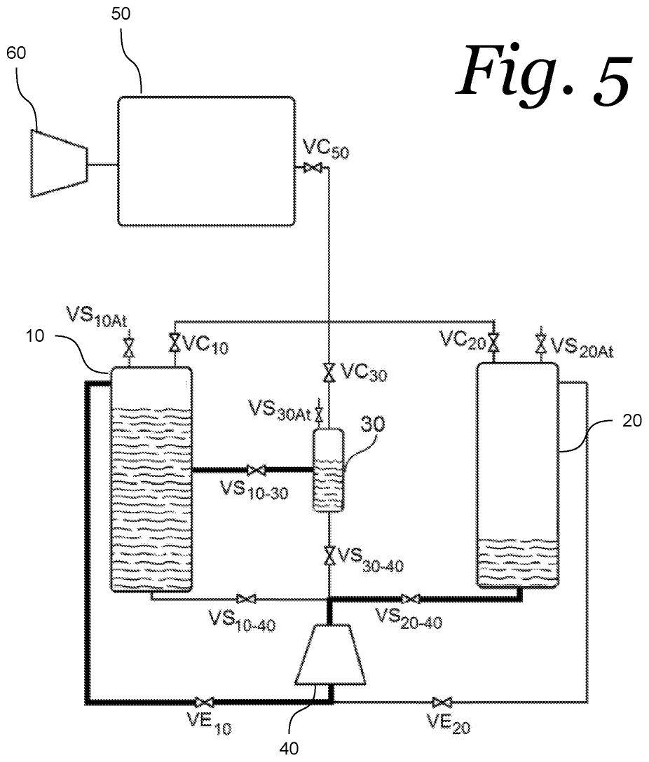

FIG. 5 shows the partial filling of the first main tank 10 and the filling of auxiliary tank 30. The intermediate step shown in FIG. 5 is the fact that once the liquid level in the first main tank 10 is high enough, the liquid fills the auxiliary tank 30. The auxiliary tank ventilation valve VS30At is opened to allow filling of the auxiliary tank 30. When this stage is finished, the system is in the initial configuration shown in FIG. 2. The liquid path is shown in FIG. 5 by a thicker layout of the pipes connecting the various components.

Additional improvements can be made to retain some of the pressure discharge being vented into the atmosphere. This energy loss represents 9 to 15% depending on the working pressure at which the system of the present invention is operating.

### Application Example

If one wishes to generate energy with a Francis turbine that produces 1.2 MW, with a water column of 60 m, a flow rate of 1.24 m³/s (cubic meter per second), with first and second main tanks of liquid, in this case water, containing 350 m³ each, with an auxiliary tank of 25 m³, with a duration of 4 hours, then a working pressure of 8 bar is needed, the discharge time from the first main tank 10 to the second main tank 20 is approximately 4.5 minutes. The auxiliary tank 30 provides a 20 second window to make the switch over. Approximately 54 cycles are required to operate for 4 hours.

To store the pressure at 100 bar, a high-pressure primary tank 50 of approximately 1000 m³ is required. If the pressure is stored at 200 bar, a high-pressure primary tank 50 of approximately 535 [m3] is required. The high-pressure primary tank 50 preferably has a cylindrical shape of approximately 10 meters high and a radius of 4 meters.

The present invention can be used to store energy and produce electricity under demand. In addition, an objective for land and power usage have been presented.

### LIST OF REFERENCES

10 First main tank
20 Second main tank
30 Auxiliary Tank
40 Turbine
50 Primary Tank
60 Compressor
VS10At First main tank ventilation valve
VS20At Second main tank ventilation valve
VS30At Auxiliary tank ventilation valve
VC10 First main tank control valve
VC20 Second main tank control valve
VC30 Auxiliary tank control valve
VC50 Primary tank pressure-regulating valve
VS10-30 First main tank to auxiliary tank outlet valve
VS10-40 First main tank to turbine outlet valve
VS20-40 Second main tank to turbine outlet valve
VS30-40 Auxiliary tank to turbine outlet valve
VE10 First main tank inlet valve
VE20 Second main tank inlet valve

What is claimed is:

1. A system for storing and generating energy, where a pressure generated by a working fluid is released into a liquid circuit which in turn moves a liquid turbine to generate energy, the system comprising:
a first main tank (10);
a second main tank (20);
an auxiliary tank (30), wherein said first main tank, second main tank and said auxiliary tank comprise a driving liquid;
a turbine (40) located between the first main tank (10) and said second main tank (20), and at a lower level than the bottom of the first (10) and second (20) main tanks and the auxiliary tank (30), to ensure that the pressure inside said main tank and said second main tank forces said driving liquid through said turbine (40) and not in the opposite direction; and
a network of pipelines with their respective valves, including inlet valves, outlet valves, control valves as well as ventilation valves, wherein the operation is performed in short cycles and at a constant working pressure by means of a control system acting on at least one pressure regulating valve, which provides the working pressure of the system.

2. The system for storing and generating energy according to claim 1, wherein the pressure inside the tanks is generated by compressed air.

3. The system to store and generate energy according to claim 2, further comprises a compressor (60) and a high-pressure primary tank (50) for the production of the compressed air.

4. The system to store and generate energy according to claim 2, wherein the compressed air is provided by compressed-air remnants from external sources.

5. The system to store and generate energy according to claim 1, wherein the pressure inside the tanks is generated by a cryogenic liquid which, when injected into the tanks, heats-up and expands, generating pressure.

6. The system to store and generate energy according to claim 1, wherein said respective valves of said pipeline network are opened or closed to allow the movement of liquid flow between said first main tank and said second main tank (20) through said turbine (40).

7. The system to store and generate energy according to claim 1, wherein said auxiliary tank (30) only works while the system is changing from operating in one direction or in the opposite direction, for the transfer of liquid between said first main tank (10) and said second main tank (20).

8. The system to store and generate energy according to claim 1, wherein said first main tank (10) and said auxiliary tank (30) must be filled with a predetermined amount of liquid, while the second main tank (20) is left without liquid.

9. The system for storing and generating energy according to claim 1, wherein said driving liquid comprises any liquid that is not mixable with the working fluid that provides the pressure.

10. The system to store and generate energy according to claim 9, wherein said driving liquid is water and said working fluid is gaseous air.

11. The system to store and generate energy according to claim 9, wherein said driving liquid is water and said working fluid is gaseous nitrogen.

12. The system to store and generate energy according to claim 1, wherein said control system acts on the inlet valves, outlet valves, control valves and ventilation valves.

13. A method to store and generate energy, where a pressure generated by a fluid is released into a liquid circuit which in turn moves a liquid turbine to generate energy, comprising the steps of:
a) providing a system that comprises a first main tank (10) of liquid with a predetermined level of liquid inside and a second main tank (20) of liquid without liquid inside, an auxiliary tank (30) of liquid with a predetermined level of liquid inside it, a turbine (40) of liquid located between the first (10) and second (20) main tanks, and at a lower level than the bottom level of the first (10) and second (20) main tanks and the auxiliary tank (30), to ensure that the working fluid forces the liquid through the turbine (40) and not in the opposite sense, a network of pipes with their respective valves, including inlet valves, outlet valves, control valves as well as ventilation valves, wherein the operation is performed in short cycles and at a constant pressure by means of a control system that acts on at least one pressure regulating valve;
b) pressurizing the first main tank (10), the auxiliary tank (30) and the piping network to an operating pressure;
c) opening the first main tank to turbine outlet valve (VS10-40), the second main tank inlet valve (VE20) and the second main tank ventilation valve (VS20At) so that the liquid moves from the first tank main tank (10), through the first main tank to turbine outlet valve (VS10-40), up to the turbine (40) and then, through the second main tank inlet valve (VE20) it is discharged into the second main tank (20), while the second main tank ventilation valve (VS20At) allows that the second main tank (20) is filled up without increasing the pressure;
d) controlling the pressure of the first main tank (10) through a first main tank control valve (VC10) that controls the pressure as the liquid level decreases, thus ensuring a stable working pressure;
e) closing the first main tank to turbine outlet valve (VS10-40), the second main tank inlet valve (VE20) and the second main tank ventilation valve (VS20At) and open the auxiliary tank to turbine outlet valve (VS30-40) to allow the auxiliary tank (30) to feed the turbine (40), during the transition from one discharge mode to another, while a new operating cycle is initiated;
f) opening the first main tank ventilation valve (VS10At) and pressurize the second main tank (20) to the operating pressure by means of a second main tank control valve (VC20);
g) opening the first main tank inlet valve (VE10) so that the flow can be discharged into the first main tank (10) that is already vented or is already at atmospheric pressure;
h) opening the auxiliary tank ventilation valve (VS30At) to ventilate the pressure from the emptied auxiliary tank (30) and close the auxiliary tank to turbine outlet valve (VS30-40);
i) opening the second main tank to turbine outlet valve (VS20-40) to feed the turbine (40) from the liquid coming from the discharge of the second main tank (20);
j) closing the first main tank to auxiliary tank outlet valve (VS10-30) when the auxiliary tank (30) is at the predetermined liquid level of stage a), where this condition occurs when the liquid level in the first main tank (10) has reached the necessary level to allow that the water enters into the auxiliary tank (30) by gravity;
k) controlling the pressure of the second main tank (20) through the second main tank control valve (VC20) which controls the pressure as the liquid level lowers, thus ensuring a stable working pressure; and
l) closing all opened valves and start the stages from stage d) to stage l).

14. The method for storing and generating energy according to claim 13, further comprises pressurizing a primary tank (50) of high pressure by means of a compressor (60), or to store a gas or gas mixture at cryogenic temperature, before said step (b) of pressurizing said first main tank (10).

15. The method to store and generate energy according to claim 13, further comprises filling said auxiliary tank to its predetermined level in stage a), according to stage j), is done when the liquid level of the first main tank (10) has reached the necessary level to allow that the water enters in the auxiliary tank (30), by gravity.

16. The method for storing and generating energy according to claim 13, further comprises configuring said control system to execute steps b) to l).
